(19) United States
(12) Patent Application Publication
(10) Pub. No.: US 2021/0017432 A1
(43) Pub. Date: Jan. 21, 2021

(54) COMPOSITIONS, METHOD OF BONDING, AND BONDED ASSEMBLY

(71) Applicant: 3M INNOVATIVE PROPERTIES COMPANY, St Paul, MN (US)

(72) Inventors: Kolby L. White, Woodbury, MN (US); Joseph D. Rule, Woodbury, MN (US); Michael A. Kropp, Cottage Grove, MN (US); Zachary J. Thompson, Woodbury, MN (US)

(21) Appl. No.: 16/980,114

(22) PCT Filed: Mar. 5, 2019
(86) PCT No.: PCT/IB2019/051774

§ 371 Date: Sep. 11, 2020

Related U.S. Application Data
(60) Provisional application No. 62/643,888, filed on Mar. 16, 2018.

(51) Int. Cl. C09J 181/00; C08G 18/80; C08G 18/79; C08G 18/38; C08G 18/32; C08G 18/28; C08G 18/22; C08G 18/20; C08G 18/18; C08G 18/16; B32B 7/12; B32B 37/12

(52) U.S. Cl. CPC C09J 181/00; B32B 2037/1269; C08G 18/798; C08G 18/3876; C08G 18/3206; C08G 18/2875; C08G 18/2825; C08G 18/227; C08G 18/2063; C08G 18/2054; C08G 18/2027; C08G 18/2018; C08G 18/1833; C08G 18/1825; C08G 18/1816; C08G 18/168; B32B 7/12; B32B 37/12; C08G 2170/00; C08G 18/8064

(57) ABSTRACT

A two-part curable composition comprises a Part A and a Part B. Part A composition includes uretdione-containing compound having an average uretdione ring functionality of at least 1.2. Part B composition includes polythiol having an average sulfhydryl group functionality of at least 2. At least one of the Part A composition and the Part B composition may further comprise accelerator for addition of the polythiol to the uretdione-containing compound. The accelerator comprises a nonacidic amine curative. The amine curative does not comprise a substituted or unsubstituted amidine group. Cured compositions, methods of making them and articles including them are also disclosed. A two-part composition without accelerator is disclosed wherein the uretdione-containing compound has at least one pendant —CH₂NR⁴₂ groups, wherein each R⁴ independently represents an alkyl group having from 1 to 8 carbon atoms, or two R⁴ groups taken together form an alkylene group having from 2 to 8 carbon atoms.

### TECHNICAL FIELD

The present disclosure broadly relates to compositions that include uretdione rings and methods of making and using them.

### BACKGROUND

Two-part urethane adhesives, sealants and coatings are commercially available from 3M and other companies. These systems typically involve one component that is an isocyanate-terminated oligomer and a second component that is a polyol. When combined, the isocyanate reacts with the polyol to form carbamate groups. While this is established and effective chemistry, it suffers from a sensitivity to moisture and from various regulatory concerns.

It would be desirable to have alternatives to isocyanates for use in compositions such as adhesives and/or sealants that perform comparably to, or better than, the current isocyanate-based formulations in one or more applications.

### SUMMARY

Advantageously, compositions and methods according to the present disclosure may exhibit properties (e.g., pot-life, open time, cure time, and/or adhesion) as adhesives and/or sealants that perform comparably to, or better than, the current isocyanate-based formulations.

In one aspect, the present disclosure provides a two-part curable composition comprising:
a Part A composition comprising at least one uretdione-containing compound, the at least one uretdione-containing compound having an average uretdione ring functionality of at least 1.2;
a Part B composition comprising at least one thiol-containing compound, the at least one thiol-containing compound having an average sulfhydryl group functionality of at least 2; and
wherein at least one of the Part A composition and the Part B composition further comprises at least one accelerator for ring-opening addition of the at least one thiol-containing compound to the at least one uretdione-containing compound, wherein the at least one accelerator comprises a nonacidic amine curative comprising pyridine, a substituted pyridine having 5 to 23 carbon atoms, or an amine having the formula NR¹R²R³ wherein:
   R¹ represents H or a monovalent organic group having from 1 to 18 carbon atoms;
   R² represents H or a monovalent organic group having from 1 to 18 carbon atoms;
   R³ represents a monovalent organic group having from 2 to 18 carbon atoms; or
   R² and R³ taken together represent a divalent organic group having from 2 to 18 carbon atoms, or
   R¹, R², and R³ taken together represent a trivalent organic group having from 2 to 18 carbon atoms; and
wherein the amine curative does not comprise a substituted or unsubstituted amidine group.

In another aspect, the present disclosure provides a cured composition comprising an at least partially cured reaction product of a curable composition comprising:
at least one uretdione-containing compound, the at least one uretdione-containing compound having an average uretdione ring functionality of at least 1.2;
at least one thiol-containing compound, the at least one thiol-containing compound having an average sulfhydryl group functionality of at least 2; and
at least one accelerator for ring-opening addition of the at least one thiol-containing compound to the at least one uretdione-containing compound, wherein the at least one accelerator comprises a nonacidic amine curative comprising pyridine, a substituted pyridine having 5 to 23 carbon atoms, or an amine having the formula NR¹R²R³
   wherein:
      R¹ represents H or a monovalent organic group having from 1 to 18 carbon atoms;
      R² represents H or a monovalent organic group having from 1 to 18 carbon atoms;
      R³ represents a monovalent organic group having from 2 to 18 carbon atoms; or
      R² and R³ taken together represent a divalent organic group having from 2 to 18 carbon atoms, or
      R¹, R², and R³ taken together represent a trivalent organic group having from 2 to 18 carbon atoms; and
   wherein the amine curative does not comprise a substituted or unsubstituted amidine group.

In yet another aspect, the present disclosure provides a method of bonding first and second substrates, the method comprising:
i) providing a curable composition comprising:
   at least one uretdione-containing compound, the at least one uretdione-containing compound having an average uretdione ring functionality of at least 1.2;
   at least one thiol-containing compound, the at least one thiol-containing compound having an average sulfhydryl group functionality of at least 2; and
at least one accelerator for ring-opening addition of the at least one thiol-containing compound to the at least one uretdione-containing compound, wherein the at least one accelerator comprises a nonacidic amine curative having the formula NR¹R²R³
   wherein:
      R¹ represents H or a monovalent organic group having from 1 to 18 carbon atoms;
      R² represents H or a monovalent organic group having from 1 to 18 carbon atoms;
      R³ represents a monovalent organic group having from 2 to 18 carbon atoms; or
      R² and R³ taken together represent a divalent organic group having from 2 to 18 carbon atoms, or
      R¹, R², and R³ taken together represent a trivalent organic group having from 2 to 18 carbon atoms; and
   wherein the amine curative does not comprise a substituted or unsubstituted amidine group;
ii) contacting the curable composition with the first and second substrates; and
iii) at least partially curing the curable composition.

In yet another aspect, the present disclosure provides a bonded assembly comprising a composition sandwiched between first and second substrates, wherein the composition comprises a reaction product of a curable composition comprising:
at least one uretdione-containing compound, the at least one uretdione-containing compound having an average uretdione ring functionality of at least 1.2;
at least one thiol-containing compound, the at least one thiol-containing compound having an average sulfhydryl group functionality of at least 2; and

at least one accelerator for ring-opening addition of the at least one thiol-containing compound to the at least one uretdione-containing compound, and wherein the at least one accelerator comprises a nonacidic amine curative having the formula NR¹R²R³
wherein:
   R¹ represents H or a monovalent organic group having from 1 to 18 carbon atoms;
   R² represents H or a monovalent organic group having from 1 to 18 carbon atoms;
   R³ represents a monovalent organic group having from 2 to 18 carbon atoms; or
   R² and R³ taken together represent a divalent organic group having from 2 to 18 carbon atoms, or
   R¹, R², and R³ taken together represent a trivalent organic group having from 2 to 18 carbon atoms; and
wherein the amine curative does not comprise a substituted or unsubstituted amidine group.

In some cases, the accelerator can be incorporated directly into the uretdione-containing compound. Accordingly, in yet another aspect, the present disclosure provides a uretdione-containing compound having an average uretdione ring functionality of at least 1.2 and at least one pendant —CH₂NR⁴₂ group, wherein each R⁴ independently represents an alkyl group having from 1 to 8 carbon atoms, or two R⁴ groups taken together form an alkylene group having from 2 to 8 carbon atoms.

In yet another aspect, the present disclosure provides a two-part curable composition comprising:
a Part A composition comprising at least one uretdione-containing compound, the at least one uretdione-containing compound having an average uretdione ring functionality of at least 1.2 and at least one pendant —CH₂NR⁴₂ group, wherein each R⁴ independently represents an alkyl group having from 1 to 8 carbon atoms, or two R⁴ groups taken together form an alkylene group having from 2 to 8 carbon atoms;
   a Part B composition comprising at least one thiol-containing compound, the at least one thiol-containing compound having an average sulfhydryl group functionality of at least 2.

As used herein:
the term “ambient temperature” refers to a temperature in the range of 20 degrees Celsius (° C.) to 25° C., inclusive.
the term “amidine group” does not refer an amidine group in an imidazole ring, although the amidine group may be contained in one or more other rings (e.g., 1,5-diazabicyclo[4.3.0]non-5-ene or 1,8-diazabicyclo[5.4.0]undec-7-ene);
the term “essentially” means at least 95 percent;
the term “nonacidic” means free of acidic groups that are at least as acidic as the corresponding carboxyl group;
the term “sulfhydryl group” refers to the —SH group; and
the term “uretdione ring” refers to a divalent C₂N₂O₂ 4-membered ring having the structure:

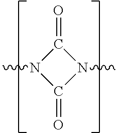

Features and advantages of the present disclosure will be further understood upon consideration of the detailed description as well as the appended claims.

### BRIEF DESCRIPTION OF THE DRAWINGS

FIG. 1 is a schematic side view of an exemplary bonded assembly according to the present disclosure.

It should be understood that numerous other modifications and embodiments can be devised by those skilled in the art, which fall within the scope and spirit of the principles of the disclosure. The figures may not be drawn to scale.

### DETAILED DESCRIPTION

The present disclosure provides two-part curable compositions, cured compositions, and assemblies including them that may be useful for instance in coatings, sealants, and/or adhesives that may have good flowability and reactivity (e.g., without added solvent), acceptable cure and/or adhesion in a short amount of time, as compared to similar compositions containing isocyanates. Further, coatings, sealants, and adhesives according to at least certain embodiments of the present disclosure may be essentially free of isocyanates. This can be advantageous because isocyanates can be sensitizers upon first contact (e.g., to skin) such that subsequent contact causes inflammation. Further, coatings, sealants, and adhesives containing isocyanates exhibit more sensitivity to water than other compounds, as noted above, so minimizing an isocyanate content in a coating, sealant, or adhesive may improve reliability during curing as well as simplify storage and handling of the polymeric materials, polymerizable compositions, and two-part compositions.

Uretdiones can be formed by the 2+2 cycloaddition reaction of two isocyanate groups and has the following general formula:

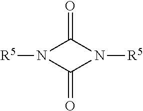

wherein each R⁵ is independently an organic residue. If one or both R groups contain an isocyanato group, then further reaction to prepare a uretdione-containing compound is possible; for example, as shown below:

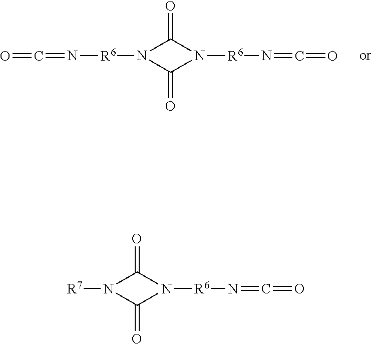

wherein R⁶ represents a divalent organic residue (preferably alkylene, arylene, or alkarylene) having from 1 to 18 carbon atoms, preferably having from 4 to 14 carbon atoms, and more preferably 4 to 8 carbon atoms, and R⁷ represents an organic residue free of isocyanato groups (preferably alkyl, aryl, aralkyl, or alkaryl) having from 1 to 18 carbon atoms, preferably having from 4 to 14 carbon atoms, and more preferably 4 to 8 carbon atoms. Reaction of residual isocyanate groups with mono-ols (monohydroxy alcohols) or polyols (polyhydroxy alcohols) can be used to convert the residual isocyanate groups to carbamate esters and, in the case of polyols, to uretdione-containing compounds having a uretdione functionality of 2 or more.

Isocyanate dimerization to form a uretdione is typically done using a catalyst. Examples of dimerization catalysts are: trialkylphosphines, aminophosphines and aminopyridines such as dimethylaminopyridines, and tris(dimethylamino)phosphine, as well as any other dimerization catalyst known to those skilled in the art. The result of the dimerization reaction depends, in a manner known to the skilled person, on the catalyst used, on the process conditions and on the polyisocyanates employed. In particular, it is possible for products to be formed which contain on average more than one uretdione group per molecule, the number of uretdione groups being subject to a distribution.

Polyisocyanates containing uretdione groups are well known and their preparation is described in, for example, U.S. Pat. No. 4,476,054 (Disteldorf et al.); U.S. Pat. No. 4,912,210 (Disteldorf et al.); and U.S. Pat. No. 4,929,724 (Engbert et al.), and in European Pat No. EP 0 417 603 (Bruchmann). The reaction, conducted optionally in solvent, but preferably without solvent, is terminated by addition of catalyst poisons when a desired conversion has been reached. Excess monomeric isocyanate is separated off afterward by short-path evaporation. If the catalyst is sufficiently volatile, the reaction mixture can be freed from the catalyst at the same time as monomer is separated off. In that case, there is no need to add catalyst poisons.

By including polyisocyanate compounds, uretdione-containing compounds having an average uretdione ring functionality greater than 1 can be prepared. As used herein, the term “polyisocyanate” means any organic compound that has two or more reactive isocyanate (—NCO) groups in a single molecule such as, for example, diisocyanates, triisocyanates, tetraisocyanates, and mixtures thereof. Exemplary polyisocyanates that can be used to prepare uretdione-containing compounds include: 1) aliphatic diisocyanates such as 1,2-ethylene diisocyanate; 1,4-tetramethylene diisocyanate; 1,6-hexamethylene diisocyanate; 2,2,4-trimethyl-1,6-hexamethylene diisocyanate; 2,4,4-trimethyl-1,6-hexamethylene diisocyanate; 1,9-diisocyanato-5-methylnonane; 1,8-diisocyanato-2,4-dimethyloctane; 1,12-dodecane diisocyanate; ω,ω′-diisocyanatodipropyl ether; cyclobutene 1,3-diisocyanate; cyclohexane 1,3-diisocyanate; cyclohexane 1,4-diisocyanate; 3-isocyanatomethyl-3,5,5-trimethylcyclohexyl isocyanate, 1,4-diisocyanatomethyl-2,3,5,6-tetramethylcyclohexane; decahydro-8-methyl-(1,4-methanol-naphthalen)-2,5-ylenedimethylene diisocyanate; decahydro-8-methyl-(1,4-methanol-naphthalen)-3,5-ylenedimethylene diisocyanate; hexahydro-4,7-methanoindan-1,5-ylenedimethylene diisocyanate; hexahydro-4,7-methanoindan-2,5-ylenedimethylene diisocyanate; hexahydro-4,7-methanoindan-1,6-ylenedimethylene diisocyanate; hexahydro-4,7-methanoindan-2,5-ylenedimethylene diisocyanate, hexahydro-4,7-methanoindan-1,5-ylene diisocyanate; hexahydro-4,7-methanoindan-2,5-ylene diisocyanate; hexahydro-4,7-methanoindan-1,6-ylene diisocyanate; hexahydro-4,7-methanoindan-2,6-ylene diisocyanate; 2,4-hexahydrotolylene diisocyanate; 2,6-hexahydrotolylene diisocyanate; 4,4′-methylenedicyclohexyl diisocyanate; 2,2′-methylenedicyclohexyl diisocyanate; 2,4-methylenedicyclohexyl diisocyanate; 4,4′-diisocyanato-3,3′,5,5′-tetramethyldicyclohexylmethane; 4,4′-diisocyanato-2,2′,3,3,5,5′,6,6′-octamethyldicyclohexylmethane; ω,ω′-diisocyanato-1,4-diethylbenzene; 1,4-diisocyanatomethyl-2,3,5,6-tetramethylbenzene; 2-methyl-1,5-diisocyanatopentane; 2-ethyl-1,4-diisocyanatobutane; 1,10-diisocyanatodecane; 1,5-diisocyanatohexane; 1,3-diisocyanatomethylcyclohexane; 1,4-diisocyanatomethylcyclohexane; 2) aromatic diisocyanates such as 2,4-diphenylmethane diisocyanate; 4,4′-biphenylene diisocyanate; 3,3′-dimethoxy-4,4′-biphenyl diisocyanate; 3,3′-dimethyl-4,4′-biphenyl diisocyanate; 3,3′-dimethyl-4,4′-diphenylmethane diisocyanate; xylene diisocyanate; 3-methyldiphenylmethane-4,4′-diisocyanate; 1,1-bis(4-isocyanatophenyl)cyclohexane; m- or p-phenylene diisocyanates; chlorophenylene-2,4-diisocyanate; 1,5-diisocyanatonaphthalene; 4,4′-biphenyl diisocyanate; 3,5′-dimethyldiphenyl-4,4′-diisocyanate; diphenyl ether-4,4′-diisocyanate; and 3) combinations thereof. Triisocyanates which may be used include, for example, trimerized isocyanurate versions of the diisocyanates listed above (e.g., the isocyanurate trimer of 1,6-hexamethylene diisocyanate and related compounds such as DESMODUR N 3300 from Covestro LLC, Pittsburgh, Pa.). Preferred compounds include, for example, uretdione-containing compounds derived from hexamethylene diisocyanate.

Mono-functional isocyanates may also be used (e.g., to vary the uretdione-containing compound average uretdione ring functionality. Examples include vinyl isocyanate; methyl isocyanatoformate; ethyl isocyanate; isocyanato(methoxy)methane; allyl isocyanate; ethyl isocyanatoformate; isopropyl isocyanate; propyl isocyanate; trimethylsilyl isocyanate; ethyl isocyanatoacetate; butyl isocyanate; cyclopentyl isocyanate; 2-isocyanato-2-methyl-propionic acid methyl ester; ethyl 3-isocyanatopropionate; 1-isocyanato-2,2-dimethylpropane; 1-isocyanato-3-methylbutane; 3-isocyanatopentane; pentyl isocyanate; 1-ethoxy-3-isocyanatopropane; phenyl isocyanate; hexyl isocyanate; 1-adamantyl isocyanate; ethyl 4-(isocyanatomethyl)cyclohexanecarboxylate; decyl isocyanate; 2-ethyl-6-isopropylphenyl isocyanate; 4-butyl-2-methylphenyl isocyanate; 4-pentylpheny]isocyanate; undecyl isocyanate; 4-biphenylyl isocyanate; 4-phenoxyphenyl isocyanate; 2-benzylphenyl isocyanate; 4-benzylphenyl isocyanate; diphenylmethyl isocyanate; 4-(benzyloxy)phenyl isocyanate; hexadecyl isocyanate; octadecyl isocyanate; and combinations thereof.

The conversion of uretdione-containing compounds having a single uretdione ring to a uretdione-containing compound having at least 2 uretdione rings (i.e., a polyuretdione) may be accomplished by reaction of the free NCO groups with hydroxyl-containing compounds, which include monomers, polymers, or mixtures thereof. Examples of such compounds include, but are not limited to, polyesters, polythioethers, polyethers, polycaprolactams, polyepoxides, polyesteramides, polyurethanes or low molecular mass di-, tri- and/or tetraols as chain extenders, and if desired, mono-ols as chain terminators, for example, as described in EP 0 669 353, EP 0 669 354, DE 30 30 572, EP 0 639 598, EP 0 803 524, and U.S. Pat. No. 7,709,589. Useful uretdione-containing compounds may optionally contain isocyanurate, biuret, and/or iminooxadiazinedione groups in addition to the uretdione groups.

Uretdione-containing compounds having at least 2 uretdione groups, such as from 2 to 10 uretdione groups, and typically containing from 5 to 45% uretdione, 10 to 55% urethane, and less than 2% isocyanate groups are disclosed in U.S. Pat. No. 9,080,074 (Schaffer et al.).

Some preferred uretdione-containing compounds can be formed by derivatization of a hexamethylene diisocyanate-based blend of materials comprising uretdione functional groups, commercially available as DESMODUR N3400 from Covestro, Pittsburgh, Pa. Additional uretdione-containing compounds are commercially available from Covestro as CRELAN EF 403, CRELAN LAS LP 6645, CRELAN VP LS 2386, and METALINK U/ISOQURE TT from Isochem Incorporated, New Albany, Ohio.

The uretdione-containing compound has an average uretdione ring functionality of at least 1.2. Accordingly, at least some components of the uretdione-containing compound contain more than one uretdione functional group. In some embodiments, the uretdione-containing compound has an average uretdione ring functionality of at least 1.2, at least 1.3, at least 1.4, at least 1.5, at least 1.6, or even at least 1.7, up to and including 1.8, 1.9, 2.0, 2.1, 2.2, 2.3, 2.4, 2.5, 2.6, 2.7, 2.8, 2.9, 3, or more, in any combination. For example, the average uretdione ring functionality of the uretdione-containing compound may be, for example, ≥1.2, 1.2 to 3, inclusive, or 1.3 to 2.6, inclusive, of a uretdione functional group in a backbone of the polymeric material.

As mentioned hereinabove, polyols can be used to create uretdione-containing compounds having an average uretdione ring functionality of greater than 1 (e.g., at least 2 or at least 3).

One exemplary simplified general reaction scheme of a uretdione-containing compound with a polyol and a mono-ol is provided in exemplary Scheme 1 (below), wherein Z and L represent divalent organic linking groups, and R represents a monovalent organic group;

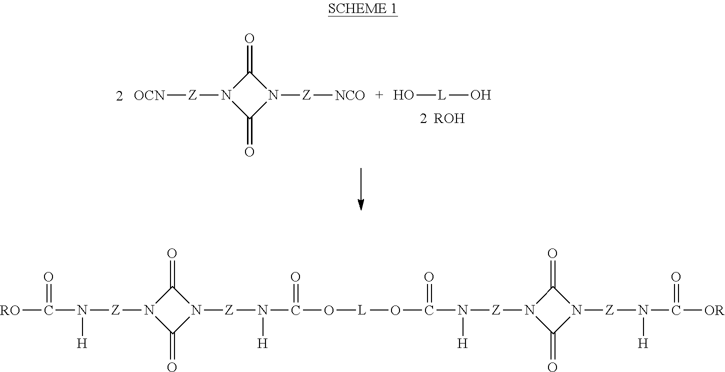

The at least one uretdione-containing compound also typically comprises one or more carbamylene (—O—C(═O)NH—) groups per molecule. The carbamylene groups can be formed by the reaction of polyol(s) with the isocyanate groups present on uretdione-containing compounds. For example, the at least one uretdione-containing compound may have an average of at least 2, at least 2.5, at least 3, at least 4, at least 5, or even at least 6 carbamylene groups up to 6, 7, 8, 9, 10, 11, 12, 13, 14, or even 15 carbamylene groups, or more, in any combination. For example, the at least one uretdione-containing compound may have an average of 2 to 15, inclusive, or 2 to 10, inclusive, of carbamylene groups.

Useful mono-ols may be primary, secondary, tertiary, linear, cyclic, and/or branched, for example. They may include, for example, C₁ to C₆ alkanols (e.g., methanol, ethanol, propanol, hexanol, cyclohexanol), C₃ to C₈ alkoxyalkanols (e.g., methoxyethanol, ethoxyethanol, propoxy propanol, or ethoxydodecanol), and polyalkylene oxide mono-ols (e.g., mono methyl-terminated polyethylene oxide or mono ethyl-terminated polypropylene oxide). Other mono-ols can also be used, as will be understood by those of ordinary skill in the art. Some preferred mono-ols include 2-butanol, isobutanol, methanol, ethanol, propanol, pentanol, hexanol, and 2-ethylbutanol. Preferred mono-ols may have branched structures or secondary hydroxyl groups that help maintain flowability of the uretdione-containing oligomers with high solids content including, for example, 2-butanol, isobutanol, 2-ethylhexanol, and more preferably 2-butanol.

Suitable polyols may be primary, secondary, tertiary, linear, cyclic, and/or branched, for example. They may be, for example, an alkylene polyol, a polyester polyol, or a polyether polyol. Often the polyol is a diol, such as a branched diol. Exemplary suitable polyols include branched alcohols, secondary alcohols, and polyether glycols. Examples include straight or branched chain alkane polyols, such as 1,2-ethanediol, 1,3-propanediol, 1,2-propanediol, 1,4-butanediol, 1,3-butanediol, 2-methyl-1,3-propanediol, glycerol, neopentyl glycol, trimethylolethane, trimethylolpropane, di-trimethylolpropane, erythritol, pentaerythritol and di-pentaerythritol, 2-ethylhexane-1,3-diol; polyalkylene glycols, such as di-, tri- and tetraethylene glycol, and di-, tri- and tetrapropylene glycol; cyclic alkane polyols, such as cyclopentanediol, cyclohexanediol, cyclohexanetriol, cyclohexanedimethanol, hydroxypropylcyclohexanol and cyclohexanediethanol; aromatic polyols, such as dihydroxybenzene, benzenetriol, hydroxybenzyl alcohol and dihydroxytoluene; bisphenols, such as 4,4′-isopropylidenediphenol (bisphenol A); 4,4′-oxybisphenol, 4,4′-dihydroxybenzophenone, 4,4′-thiobisphenol, phenolphthalein, bis(4-hydroxyphenyl)methane (bisphenol F), 4,4′-(1,2-ethenediyl)bisphenol and 4,4′-sulfonylbisphenol; halogenated bisphenols, such as 4,4′-isopropylidenebis(2,6-dibromophenol), 4,4′-isopropylidenebis(2,6-dichlorophenol) and 4,4′-isopropylidenebis(2,3,5,6-tetrachlorophenol); alkoxylated bisphenols, such as alkoxylated 4,4′-isopropylidenediphenol having one or more alkoxy groups, such as ethoxy, propoxy, alpha-butoxy and beta-butoxy groups; and biscyclohexanols, which can be prepared by hydrogenating the corresponding bisphenols, such as 4,4′-isopropylidene-biscyclohexanol, 4,4′-oxybiscyclohexanol, 4,4′-thiobiscyclohexanol and bis(4-hydroxycyclohexanol)methane; higher polyalkylene glycols, such as polyethylene glycols having a number average molecular weight (Mₙ) of from 200 to 2000 grams per mole; hydroxyl-bearing acrylics, such as those formed from the copolymerization of (meth)acrylates and hydroxy functional (meth)acrylates, such as methyl methacrylate and hydroxyethyl methacrylate copolymers; and hydroxy functional polyesters, such as those formed from the reaction of diols, such as butanediol, and diacids or diesters, such as adipic acid or diethyl adipate; and combinations thereof. Preferred diols may have branching or secondary hydroxyl groups that help maintain flowability of the uretdione-containing oligomers with high solids content including, for example, 1,3-butanediol and neopentyl glycol.

In some preferred embodiments, the polyol has from 2 to 50 carbon atoms, preferably from 2 to 18 carbon atoms, and more preferably 2 to 8 carbon atoms. In some preferred embodiments, the polyol is polymeric and has from 10 to 200 carbon atoms. Examples include hydroxyl-terminated polyetherdiols and hydroxyl-terminated polyester diols.

Useful commercially available polyols include, for example, those from Covestro LLC, Pittsburgh, Pa., as DESMOPHEN 1652, DESMOPHEN 800, DESMOPHEN 850, DESMOPHEN C 1100, DESMOPHEN C 1200, DESMOPHEN C 2100, DESMOPHEN C 2200, and DESMOPHEN C XP 2716.

Useful thiol-containing compounds are organic compounds having at least 1, at least 2, at least 3, at least 4, or even at least 6 thiol groups. Suitable thiol-containing compounds having a single —SH group may include, for example, ethanethiol, 1-propanethiol, 1-butanethiol, 6-mercapto-1-hexanol, 3-mercapto-1-hexanol, 4-mercapto-4-methylpentan-2-ol, 3-mercaptobutyl acetate, 8-mercapto-1-octanol, 9-mercapto-1-nonanol, 1-nonanethiol, 1-decanethiol, and 3-mercaptohexyl hexanoate.

Combinations of thiol-containing compounds may be used. The average thiol functionality of the at least one thiol-containing compound is at least 2. Preferably, the average thiol functionality of the at least one thiol-containing compound is from 2 to 7, more preferably 2 to 5, more preferably 2.5 to 4.5, and more preferably 3.7 to 4.3. Preferred combinations include miscible mixtures, although this is not a requirement.

Many thiol-containing compounds having one thiol group are useful in practice of the method according to the present disclosure.

Many thiol-containing compounds having at least two thiol groups (i.e., polythiols) are useful in practice of the method according to the present disclosure. In some embodiments, polythiol may be an alkylene, arylene, alkylarylene, arylalkylene, or alkylenearylalkylene having at least two mercaptan groups, wherein any of the alkylene, alkylarylene, arylalkylene, or alkylenearylalkylene are optionally interrupted by one or more oxa (i.e., —O—), thia (i.e., —S—), or imino groups (i.e., —NR³— wherein R³ is a hydrocarbyl group or H), and optionally substituted by alkoxy or hydroxyl.

Examples of useful dithiols include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethyl sulfide, methyl-substituted dimercaptodiethyl sulfide, dimethyl-substituted dimercaptodiethyl sulfide, dimercaptodioxaoctane, 1,5-dimercapto-3-oxapentane, benzene-1,2-dithiol, benzene-1,3-dithiol, benzene-1,4-dithiol, and tolylene-2,4-dithiol. Examples of polythiols having more than two mercaptan groups include propane-1,2,3-trithiol; 1,2-bis[(2-mercaptoethyl)thio]-3-mercaptopropane; tetrakis(7-mercapto-2,5-dithiaheptyl)methane; and trithiocyanuric acid.

Also useful are polythiols formed from the esterification of polyols with thiol-containing carboxylic acids or their derivatives. Examples of polythiols formed from the esterification of polyols with thiol-containing carboxylic acids or their derivatives include those made from the esterification reaction between thioglycolic acid or 3-mercaptopropionic acid and several polyols to form the mercaptoacetates or mercaptopropionates, respectively.

Examples of polythiol compounds preferred because of relatively low odor level include, but are not limited to, esters of thioglycolic acid, α-mercaptopropionic acid, and β-mercaptopropionic acid with polyhydroxy compounds (polyols) such as diols (e.g., glycols), triols, tetraols, pentaols, and hexaols. Specific examples of such polythiols include, but are not limited to, ethylene glycol bis(thioglycolate), ethylene glycol bis(β-mercaptopropionate), trimethylolpropane tris(thioglycolate), trimethylolpropane tris(β-mercaptopropionate) and ethoxylated versions, pentaerythritol tetrakis(thioglycolate), pentaerythritol tetrakis(β-mercaptopropionate), and tris(hydroxyethyl)isocyanurate tris(β-mercaptopropionate). However, in those applications where concerns about possible hydrolysis of the ester exists, these polyols are typically less desirable.

Suitable polythiols also include those commercially available as THIOCURE PETMP (pentaerythritol tetra(3-mercaptopropionate)), TMPMP (trimethylolpropane tri(3-mercaptopropionate)), ETTMP (ethoxylated trimethylolpropane tri(3-mercaptopropionate) such as ETTMP 1300 and ETTMP 700), GDMP glycol di(3-mercaptopropionate), TMPMA (trimethylolpropane tri(mercaptoacetate)), TEMPIC (tris[2-(3-mercaptopropionyloxy)ethyl]isocyanurate), and PPGMP (propylene glycol 3-mercaptopropionate) from Bruno Bock Chemische Fabrik GmbH & Co. KG. A specific example of a polymeric polythiol is polypropylene-ether glycol bis(β-mercaptopropionate), which is prepared from polypropylene-ether glycol (e.g., PLURACOL P201, Wyandotte Chemical Corp.) and β-mercaptopropionic acid by esterification.

Suitable polythiols also include those prepared from esterification of polyols with thiol-containing carboxylic acids or their derivatives, those prepared from a ring-opening reaction of epoxides with H₂S (or its equivalent), those prepared from the addition of H₂S (or its equivalent) across carbon-carbon double bonds, polysulfides, polythioethers, and polydiorganosiloxanes. Specifically, these include the 3-mercaptopropionates (also referred to as β-mercaptopropionates) of ethylene glycol and trimethylolpropane (the former from Chemische Fabrik GmbH & Co. KG, the latter from Sigma-Aldrich); POLYMERCAPTAN 805C (mercaptanized castor oil); POLYMERCAPTAN 407 (mercaptohydroxy soybean oil) from Chevron Phillips Chemical Co. LLP, and CAPCURE, specifically CAPCURE 3-800 (a polyoxyalkylenetriol with mercapto end groups of the structure R³[O(C₃H₆O)ₙCH₂CH(OH)CH₂SH]₃ wherein R³ represents an aliphatic hydrocarbon group having 1-12 carbon atoms and n is an integer from 1 to 25), from Gabriel Performance Products, Ashtabula, Ohio, and GPM-800, which is equivalent to CAPCURE 3-800, also from Gabriel Performance Products.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.).

In some embodiments, the polythiol in the method according to the present disclosure is oligomeric or polymeric. Examples of useful oligomeric or polymeric polythiols include polythioethers and polysulfides. Polythioethers include thioether linkages (i.e., —S—) in their backbone structures. Polysulfides include disulfide linkages (i.e., —S—S—) in their backbone structures.

Polythioethers can be prepared, for example, by reacting dithiols with dienes, diynes, divinyl ethers, diallyl ethers, ene-ynes, alkynes, or combinations of these under free-radical conditions. Useful dithiols include any of the dithiols listed above. Examples of suitable divinyl ethers include divinyl ether, ethylene glycol divinyl ether, butanediol divinyl ether, hexanediol divinyl ether, diethylene glycol divinyl ether, triethylene glycol divinyl ether, tetraethylene glycol divinyl ether, cyclohexanedimethanol divinyl ether, polytetrahydrofuryl divinyl ether, and combinations of any of these. Useful divinyl ethers of formula CH₂═CHO(R⁸O)ₘCH═CH₂, in which m is a number from 0 to 10, and R⁸ is C₂ to C₆ branched alkylene. Such compounds can be prepared by reacting a polyhydroxy compound with acetylene. Examples of compounds of this type include compounds in which R⁸ is an alkyl-substituted methylene group such as —CH(CH₃)— (e.g., those obtained from BASF, Florham Park, N.J., as “PLURIOL”, for which R⁸ is ethylene and m is 3.8) or an alkyl-substituted ethylene (e.g., —CH₂CH(CH₃)— such as those obtained from International Specialty Products of Wayne, N.J., as “DPE” (e.g., DPE-2 and DPE-3). Examples of other suitable dienes, diynes, and diallyl ethers include 4-vinyl-1-cyclohexene, 1,5-cyclooctadiene, 1,6-heptadiyne, 1,7-octadiyne, and diallyl phthalate. Small amounts of trifunctional compounds (e.g., triallyl-1,3,5-triazine-2,4,6-trione, 2,4,6-triallyloxy-1,3,5-triazine) may also be useful in the preparation of oligomers.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.). In some embodiments, the polythioether is represented by formula HSR⁹[S(CH₂)₂O[R¹⁰O]ₘ(CH₂)₂SR⁹]ₙSH, wherein each R⁹ and R¹⁰ is independently a C₂₋₆ alkylene, wherein alkylene may be straight-chain or branched, C₆₋₈ cycloalkylene, C₆₋₁₀ alkylcycloalkylene, —[(CH₂)ₚX]_{q}(CH₂)ᵣ in which at least one —CH₂— is optionally substituted with a methyl group, X is one selected from the group consisting of O, S and —NR¹¹—, where R¹¹ denotes hydrogen or methyl, m is a number from 0 to 10, n is a number from 1 to 60, p is an integer from 2 to 6, q is an integer from 1 to 5, and r is an integer from 2 to 10. Polythioethers with more than two mercaptan groups may also be useful.

Polythioethers can also be prepared, for example, by reacting dithiols with diepoxides, which may be carried out by stirring at room temperature, optionally in the presence of a tertiary amine catalyst (e.g., 1,4-diazabicyclo[2.2.2]octane (DABCO)). Useful dithiols include any of those described above. Useful epoxides can be any of those having two epoxide groups. In some embodiments, the diepoxide is a bisphenol diglycidyl ether, wherein the bisphenol (i.e., —OC₆H₅CH₂C₆H₅O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Polythioethers prepared from dithiols and diepoxides have pendent hydroxyl groups and can have structural repeating units represented by formula —SR⁹SCH₂CH(OH)CH₂OC₆H₅CH₂C₆H₅OCH₂CH(OH)CH₂SR⁹S—, wherein R⁹ is as defined above, and the bisphenol (i.e., —OC₆H₅CH₂C₆H₅O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Mercaptan terminated polythioethers of this type can also be reacted with any of the dienes, diynes, divinyl ethers, diallyl ethers, and ene-ynes listed above under free-radical polymerization conditions.

Other useful polythiols can be formed from the addition of hydrogen sulfide (H₂S) (or its equivalent) across carbon-carbon double bonds. For example, dipentene and triglycerides which have been reacted with H₂S (or its equivalent). Specific examples include dipentene dimercaptan and those polythiols available as POLYMERCAPTAN 358 (mercaptanized soybean oil) and POLYMERCAPTAN 805C (mercaptanized castor oil) from Chevron Phillips Chemical Co. LLP. At least for some applications, the preferred polythiols are POLYMERCAPTAN 358 and 805C since they are produced from largely renewable materials, i.e., the triglycerides, soybean oil and castor oil, and have relatively low odor in comparison to many thiols. Useful triglycerides have at least 2 sites of unsaturation, i.e., carbon-carbon double bonds, per molecule on average, and sufficient sites are converted to result in at least 2 thiols per molecule on average. In the case of soybean oil, this requires a conversion of approximately 42 percent or greater of the carbon-carbon double bonds, and in the case of castor oil this requires a conversion of approximately 66 percent or greater of the carbon-carbon double bonds. Typically, higher conversion is preferred, and POLYMERCAPTAN 358 and 805C can be obtained with conversions greater than approximately 60 percent and 95 percent, respectively. Useful polythiols of this type also include those derived from the reaction of H₂S (or its equivalent) with the glycidyl ethers of bisphenol A epoxy resins, bisphenol F epoxy resins, and novolak epoxy resins. A preferred polythiol of this type is QX11, derived from bisphenol A epoxy resin, from Japan Epoxy Resins (JER) as EPOMATE. Other polythiols suitable include those available as EPOMATE QX10 and EPOMATE QX20 from JER.

Still other useful polythiols are polysulfides that contain thiol groups such as those available as THIOKOL LP-2, LP-3, LP-12, LP-31, LP-32, LP-33, LP-977, and LP-980 from Toray Fine Chemicals Co., Ltd., and polythioether oligomers and polymers such as those described in PCT Publ. No. WO 2016130673 A1 (DeMoss et al.).

The at least one accelerator comprises an amine having the formula NR¹R²R³, R¹ and R² independently represent H or a monovalent organic group having from 1 to 18 carbon atoms and may contain hetero atoms such as O and N (e.g., methyl, ethyl, propyl, butyl, isobutyl, ethoxyethyl, pentyl, hexyl, cyclohexyl, phenyl, 2,4-dimethylphenyl, octyl, decyl, hexadecyl, or octadecyl); R³ represents a monovalent organic group having from 2 to 18 carbon atoms and may contain hetero atoms such as O and N (e.g., ethyl, propyl, butyl, isobutyl, ethoxyethyl, pentyl, hexyl, cyclohexyl, phenyl, 2,4-dimethylphenyl, octyl, decyl, hexadecyl, or octadecyl); or R² and R³ taken together represent a divalent organic group having from 2 to 18 carbon atoms (e.g., ethylene, propane-1,3-diyl, butane-1,4-diyl, pentane-1,5-diyl, hexane-1,6-diyl, heptane-1,7-diyl, —CH₂CH₂OCH₂CH₂—, or 2,2-diphenylpropane-1,3-diyl); or R¹, R², and R³ taken together represent a trivalent organic group having from 2 to 18 carbon atoms (e.g., nonane-1,5,9-triyl and 3-(ethyl-2′-yl)pentan-1,5-diyl).

Examples of suitable accelerators include triethylamine; 1,4-diaza[2.2.2]bicyclooctane (DABCO); aniline; N,N-dimethylaniline; 2,6-dimethylaniline; 1-methylimidazole; pyridine; N,N-dimethyl-4-aminopyridine; benzylamine; dicyclohexylamine; N,N-dicyclohexylmethylamine; 4-methylmorpholine; cyclohexylamine; piperidine; morpholine; 1-[bis[3-(dimethylamino)propyl]amino]-2-propanol; 1-methylpiperidine; quinuclidine; 2,2,6,6-tetramethylpiperidine; 1-methylpyrrolidine; N-benzylmethylamine; 1,2,2,6,6-pentamethylpiperidine; 2-{[2-(dimethylamino)ethyl]methylamino}ethanol; 3-dimethylamino-1-propanol; and 2-[2-(dimethylamino)ethoxy]ethanol.

Examples of suitable accelerators include substituted pyridines having 5 to 23 carbon atoms. Substituted pyridines include chloropyridine, bromopyridine, fluoropyridine, iodopyridine, methylpyridine, ethylpyridine, propylpyridine, tert-butylpyridine, phenylpyridine, methoxypyridine, ethoxypyridine, phenoxypyridine, nitropyridine, dichloropyridine, dibromopyridine, dimethylpyridine, diethylpyridine, di-tert-butylpyridine, methyl nicotinate, ethyl nicotinate, methyl picolinate, ethyl picolinate, methyl isonicotinate, cyanopyridine, and trimethylpyridine.

Commercially available accelerators include a trifunctional amine-terminated polyether available as JEFFAMINE T-403 Polyetheramine and difunctional amine-terminated polyether available as JEFFAMINE THF-100 Polyetheramine, both from Huntsman Corp.; 1,3-benzenedimethanamine, reaction products with epichlorohydrin, available as GASKAMINE 328; and aspartic acid, secondary diamine available as Desmophen NH1220 from Covestro LLC.

In some preferred embodiments, the at least one accelerator is free of substituted or unsubstituted imidazole, amidine, and/or triazole groups.

In some embodiments, the accelerator can be incorporated directly into the uretdione-containing compound by incorporating at least one pendant —CH₂NR⁴₂ group wherein each R⁴ independently represents an alkyl group having from 1 to 8 carbon atoms, or two R⁴ groups taken together form an alkylene group having from 2 to 8 carbon atoms. Such compounds can be formed as described above for reactions of mono-ols with uretdione ring-containing compounds with one of more isocyanate groups, except that a tertiary aminoalcohol is used instead. Advantageously, such reactions may be self-catalyzing due to the tertiary amino group. Exemplary aminoalcohols include N,N-dimethyl-2-amino-1-ethanol, N,N-diethyl-2-amino-1-ethanol, N,N-dimethyl-3-amino-1-propanol, N,N-dimethyl-4-amino-1-butanol, N,N-dimethyl-6-amino-1-hexanol, and N,N-dibutyl-8-amino-1-octanol.

Curable and cured compositions according to the present disclosure may further comprise one or more additives such as, for example, plasticizers, non-reactive diluents, fillers, flame retardants, and colorants.

A plasticizer is often added to the curable composition to make the polymeric material more flexible, softer, and more workable (e.g., easier to process). More specifically, the mixture resulting from the addition of the plasticizer to the polymeric material typically has a lower glass transition temperature compared to the polymeric material alone. The glass transition temperature of the curable composition can be lowered, for example, by at least 30° C., at least 40° C., at least 50° C., at least 60° C., or even at least 70° C. by the addition of one or more plasticizers. The temperature change (i.e., decrease) tends to correlate with the amount of plasticizer added to the polymeric material. It is the lowering of the glass transition temperature that usually leads to the increased flexibility, increased elongation, and increased workability. Some example plasticizers include various phthalate esters such as diethyl phthalate, diisobutyl phthalate, dibutyl phthalate, diisoheptyl phthalate, dioctyl phthalate, diisooctyl phthalate, dinonyl phthalate, diisononyl phthalate, diisodecyl phthalate, and benzylbutyl phthalate; various adipate esters such as di-2-ethylhexyl adipate, dioctyl adipate, diisononyl adipate, and diisodecyl adipate; various phosphate esters such as tri-2-ethylhexyl phosphate, 2-ethylhexyl diphenyl phosphate, trioctylphosphate, and tricresyl phosphate; various trimellitate esters such as tris-2-ethylhexyl trimellitate and trioctyl trimellitate; various sebacate and azelate esters; and various sulfonate esters. Other example plasticizers include polyester plasticizers that can be formed by a condensation reaction of propanediols or butanediols with adipic acid.

In certain embodiments, the curable composition is used in an application where it is disposed between two substrates, wherein solvent removal (e.g., evaporation) is restricted, especially when one or more of the substrates comprises a moisture impermeable material (e.g., steel or glass). In such cases, the polymeric material comprises a solids content of 90% or greater, 92% or greater, 94% or greater, 95% or greater, 96% or greater, 98% or greater, or 99% or greater. Likewise, in such embodiments where solvent removal is restricted, the first part (Part A), the second part (Part B), or both parts of a two-part curable composition according to the present disclosure preferably comprises a solids content of at least 90%, at least 92%, at least 94%, at least 95%, at least 96%, at least 98%, or even at least 99%. Components that are considered “solids” include, for instance and without limitation, polymers, oligomers, monomers, hydroxyl-containing compounds, and additives such as plasticizers, catalysts, non-reactive diluents, and fillers. Typically, only solvents (e.g., water, organic solvent(s), and combinations thereof) do not fall within the definition of solids.

For convenient handleability, the curable composition typically comprises a dynamic viscosity of 10 Poise (P) or greater as determined using a Brookfield viscometer, 50 P or greater, 100 P or greater, 150 P or greater, 250 P or greater, 500 P or greater, 1,000 P or greater, 1,500 P or greater, 2,000 P or greater, 2,500 P or greater, or even 3,000 P or greater; and 10,000 P or less, 9,000 P or less, 8,000 P or less, 7,000 P or less, 6,000 P or less, 5,000 P or less, or even 4,000 P or less, as determined using a Brookfield viscometer. Stated another way, the polymeric material may exhibit a dynamic viscosity of 10 Poise (P) to 10,000 P, inclusive, or 10 P to 4,000 P, inclusive, as determined using a Brookfield viscometer. Conditions for the dynamic viscosity test include use of a LV4 spindle at a speed of 0.3 or 0.6 revolutions per minute (RPM) at 24° C.

Depending on the particular application, an amount of each of the Part A and the Part B obtained will vary; in certain embodiments, an excess of one or both of the Part A and the Part B is obtained and hence only a portion of one or both of the Part A and the Part B, respectively, will be combined to form a mixture. In other embodiments, however, a suitable amount of each of the Part A and the Part B for adhering the first and second substrates together is obtained and essentially all of the Part A and the part B is combined to form the mixture. In certain embodiments, combining a (e.g., predetermined) amount of the Part A with a (e.g., predetermined) amount of the Part B is performed separately from the first and second substrates, while in other embodiments the combining is performed (e.g., directly) on the first major surface of a substrate.

Curable compositions according to the present disclosure may be used to bond two substrates together to form a bonded assembly. In general, Part A and Part B are combined to form a curing composition, which is then applied to one or both substrate, and pressed together to form an adhesive bond after curing. If used as a sealant pressing may not be performed. After curing a bonded assembly results.

The mixture is typically applied to (e.g., disposed on) the surface of one or both substrate using conventional techniques such as, for example, dispensing, bar coating, roll coating, curtain coating, rotogravure coating, knife coating, spray coating, spin coating, or dip coating techniques. Coating techniques such as bar coating, roll coating, and knife coating are often used to control the thickness of a layer of the mixture. In certain embodiments, the disposing comprises spreading the mixture on the first major surface of the first substrate, for instance when the mixture is dispensed (e.g., with a mixing nozzle) on the surface of the substrate such that the mixture does not cover the entirety of a desired area.

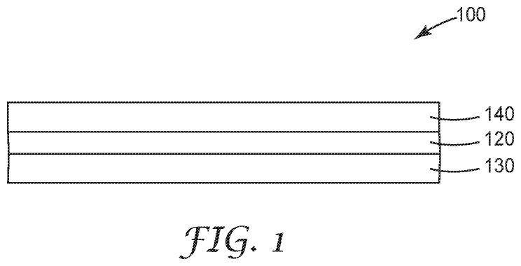

Referring to FIG. 1, a bonded assembly 100 is illustrated. The bonded assembly 100 comprises at least partially cured composition 120 (e.g., an adhesive) sandwiched between first and second substrates (130, 140).

Advantageously, the two-part curable compositions when the Part A and Part B are combined are capable of adhering two substrates together. Following cure, the adhesive preferably exhibits a minimum overlap shear on aluminum of 0.3 megaPascals (MPa), 1 MPa, 5 MPa, 10 MPa, or 25 MPa.

Curable compositions according to the present disclosure are typically supplied as two-part curable compositions (i.e., a Part A and a Part B in separate containers) that are stable separately but react to cure when mixed together, although this is not a requirement.

### Select Embodiments of the Present Disclosure

In a first embodiment, the present disclosure provides a two-part curable composition comprising:
a Part A composition comprising at least one uretdione-containing compound, the at least one uretdione-containing compound having an average uretdione ring functionality of at least 1.2;
a Part B composition comprising at least one thiol-containing compound, the at least one thiol-containing compound having an average sulfhydryl group functionality of at least 2; and
wherein at least one of the Part A composition and the Part B composition further comprises at least one accelerator for ring-opening addition of the at least one thiol-containing compound to the at least one uretdione-containing compound, wherein the at least one accelerator comprises a nonacidic amine curative comprising pyridine, a substituted pyridine having 5 to 23 carbon atoms, or an amine having the formula NR¹R²R³
   wherein:
      R¹ represents H or a monovalent organic group having from 1 to 18 carbon atoms;
      R² represents H or a monovalent organic group having from 1 to 18 carbon atoms;
      R³ represents a monovalent organic group having from 2 to 18 carbon atoms; or
      R² and R³ taken together represent a divalent organic group having from 2 to 18 carbon atoms, or
      R¹, R², and R³ taken together represent a trivalent organic group having from 2 to 18 carbon atoms; and
   wherein the amine curative does not comprise a substituted or unsubstituted amidine group.

In a second embodiment, the present disclosure provides a two-part curable composition according to the first embodiment, wherein the at least one uretdione-containing compound has an average isocyanate functionality of less than 0.01.

In a third embodiment, the present disclosure provides a two-part curable composition according to the first or second embodiment, wherein the at least one thiol-containing compound has an average sulfhydryl group functionality of at least 2.5.

In a fourth embodiment, the present disclosure provides a two-part curable composition according to any one of the first to third embodiments, wherein the at least one thiol-containing compound having an average sulfhydryl group functionality of less than or equal to 5.

In a fifth embodiment, the present disclosure provides a two-part curable composition according to any one of the first to fourth embodiments, wherein the Part A composition and the Part B composition are flowable at 20° C.

In a sixth embodiment, the present disclosure provides a cured composition comprising an at least partially cured reaction product of a curable composition comprising:
at least one uretdione-containing compound, the at least one uretdione-containing compound having an average uretdione ring functionality of at least 1.2;
at least one thiol-containing compound, the at least one thiol-containing compound having an average sulfhydryl group functionality of at least 2; and
at least one at least one accelerator for ring-opening addition of the at least one thiol-containing compound to the at least one uretdione-containing compound, wherein the at least one accelerator comprises a nonacidic amine curative having the formula NR¹R²R³ wherein:
   R¹ represents H or a monovalent organic group having from 1 to 18 carbon atoms;
   R² represents H or a monovalent organic group having from 1 to 18 carbon atoms;
   R³ represents a monovalent organic group having from 2 to 18 carbon atoms; or
   R² and R³ taken together represent a divalent organic group having from 2 to 18 carbon atoms, or
   R¹, R², and R³ taken together represent a trivalent organic group having from 2 to 18 carbon atoms; and
wherein the amine curative does not comprise a substituted or unsubstituted amidine group.

In a seventh embodiment, the present disclosure provides a cured composition according to the sixth embodiment, wherein the at least one uretdione-containing compound has an average isocyanate functionality of less than 0.01.

In an eighth embodiment, the present disclosure provides a cured composition according to the sixth or seventh embodiment, wherein the at least one thiol-containing compound has an average sulfhydryl group functionality of at least 2.5.

In a ninth embodiment, the present disclosure provides a cured composition according to any one of the sixth to eighth embodiments, wherein the at least one thiol-containing compound has an average sulfhydryl group functionality of less than or equal to 5.

In a tenth embodiment, the present disclosure provides a cured composition according to any one of the sixth to ninth embodiments, wherein the curable composition is flowable at 20° C. before curing.

In an eleventh embodiment, the present disclosure provides a method of bonding first and second substrates, the method comprising:
i) providing a curable composition comprising:
   at least one uretdione-containing compound, the at least one uretdione-containing compound having an average uretdione ring functionality of at least 1.2;
   at least one thiol-containing compound, the at least one thiol-containing compound having an average sulfhydryl group functionality of at least 2; and
at least one accelerator for ring-opening addition of the at least one thiol-containing compound to the at least one uretdione-containing compound, wherein the at least one accelerator comprises a nonacidic amine curative comprising pyridine, a substituted pyridine having 5 to 23 carbon atoms, or an amine having the formula NR¹R²R³
   wherein:
      R¹ represents H or a monovalent organic group having from 1 to 18 carbon atoms;
      R² represents H or a monovalent organic group having from 1 to 18 carbon atoms;
      R³ represents a monovalent organic group having from 2 to 18 carbon atoms; or
      R² and R³ taken together represent a divalent organic group having from 2 to 18 carbon atoms, or
      R¹, R², and R³ taken together represent a trivalent organic group having from 2 to 18 carbon atoms; and
   wherein the amine curative does not comprise a substituted or unsubstituted amidine group;
ii) contacting the curable composition with the first and second substrates; and
iii) at least partially curing the curable composition.

In a twelfth embodiment, the present disclosure provides a method according to the eleventh embodiment, wherein the at least one uretdione-containing compound has an average isocyanate functionality of less than 0.01.

In a thirteenth embodiment, the present disclosure provides a method according to the eleventh or twelfth embodiment, wherein the at least one thiol-containing compound has an average sulfhydryl group functionality of at least 2.5.

In a fourteenth embodiment, the present disclosure provides a method according to any one of the eleventh to thirteenth embodiments, wherein the at least one thiol-containing compound has an average sulfhydryl group functionality of less than or equal to 5.

In a fifteenth embodiment, the present disclosure provides a method according to any one of the eleventh to fourteenth embodiments, wherein the curable composition is flowable at 20° C. before curing.

In a sixteenth embodiment, the present disclosure provides a bonded assembly comprising a composition sandwiched between first and second substrates, wherein the composition comprises a reaction product of a curable composition comprising:
at least one uretdione-containing compound, the at least one uretdione-containing compound having an average uretdione ring functionality of at least 1.2;
at least one thiol-containing compound, the at least one thiol-containing compound having an average sulfhydryl group functionality of at least 2; and
at least one accelerator for ring-opening addition of the at least one thiol-containing compound to the at least one uretdione-containing compound, and wherein the at least one accelerator comprises a nonacidic amine curative comprising pyridine, a substituted pyridine having 5 to 23 carbon atoms, or an amine having the formula NR¹R²R³ wherein:
   R¹ represents H or a monovalent organic group having from 1 to 18 carbon atoms;
   R² represents H or a monovalent organic group having from 1 to 18 carbon atoms;
   R³ represents a monovalent organic group having from 2 to 18 carbon atoms; or
   R² and R³ taken together represent a divalent organic group having from 2 to 18 carbon atoms, or
   R¹, R², and R³ taken together represent a trivalent organic group having from 2 to 18 carbon atoms; and
wherein the amine curative does not comprise a substituted or unsubstituted amidine group.

In a seventeenth embodiment, the present disclosure provides a bonded assembly according to the sixteenth embodiment, wherein the at least one uretdione-containing compound has an average isocyanate functionality of less than 0.01.

In an eighteenth embodiment, the present disclosure provides a bonded assembly according to the sixteenth or seventeenth embodiment, wherein the at least one thiol-containing compound has an average sulfhydryl group functionality of at least 2.5.

In a nineteenth embodiment, the present disclosure provides a bonded assembly according to any one of the sixteenth to eighteenth embodiments, wherein the at least one thiol-containing compound has an average sulfhydryl group functionality of less than or equal to 5.

In a twentieth embodiment, the present disclosure provides a bonded assembly according to any one of the sixteenth to nineteenth embodiments, wherein the curable composition is flowable at 20° C. before curing.

In a twenty-first embodiment, the present disclosure provides a uretdione-containing compound having an average uretdione ring functionality of at least 1.2 and at least one pendant —CH₂NR⁴₂ group, wherein each R⁴ independently represents an alkyl group having from 1 to 8 carbon atoms, or two R⁴ groups taken together form an alkylene group having from 2 to 8 carbon atoms.

In a twenty-second embodiment, the present disclosure provides a two-part curable composition comprising:
a Part A composition comprising at least one uretdione-containing compound, the at least one uretdione-containing compound having an average uretdione ring functionality of at least 1.2 and at least one pendant —CH₂NR⁴₂ group, wherein each R⁴ independently represents an alkyl group having from 1 to 8 carbon atoms, or two R⁴ groups taken together form an alkylene group having from 2 to 8 carbon atoms;
a Part B composition comprising at least one thiol-containing compound, the at least one thiol-containing compound having an average sulfhydryl group functionality of at least 2.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. Table 1 (below) lists materials used in the examples and their sources. In the Tables, “NA” means not applicable. In the examples: EX—designates working examples, CEX—designates comparative examples, and PEX—designates preparative examples.

TABLE 1

| DESIGNATION | DESCRIPTION | SOURCE |
|---|---|---|
| DN3400 | HDI-based oligomer with | Covestro, |
| | uretdione functional groups | Leverkusen, |
| | obtained as DESMODUR | Germany |
| | N3400 | |
| 2-ethyl hexanol | 2-ethylhexanol | Alfa Aesar, |
| | | Haverhill, |
| | | Massachusetts |
| 2-butanol | 2-butanol | Alfa Aesar |
| 1,3-BD | 1,3-butanediol | Alfa Aesar |
| 2,2-dimethyl-1,3-propanediol | | Alfa Aesar |
| BiND | bismuth neodecanoate | Gelest, Morrisville, |
| | | Pennsylvania |
| ZnND | zinc neodecanoate | Alfa Aesar |
| DBTDL | dibutyltin dilaurate | Alfa Aesar |
| TsOH*H₂O | p-toluenesulfonic acid | Alfa Aesar |
| | monohydrate | |
| DBU | 1,8-diazabicyclo[5.4.0]undec-7-ene | Alfa Aesar |
| AK54 | 2,4,6-tris-(dimethylaminomethyl)phenol | TCI America, |
| | obtained as ANCAMINE K54 | Portland, Oregon |
| PETMP | Pentaerythritol | TCI America |
| | tetrakis(3-mercaptopropionate) | |
| | (tetrafunctional thiol curative) | |
| DMDO | 3,6-dioxa-1,8-octane-dithiol | TCI America |
| | (difunctional thiol curative) | |
| TMPTMP | trimethylolpropane | TCI America |
| | tri(3-mercaptopropionate) | |
| | (trifunctional thiol Curative) | |
| zirconium 2,4-pentadionate | zirconium 2,4-pentadionate | Johnson Matthey, |
| | | Royston, |
| | | United Kingdom |
| Et₃N | triethylamine | EMD Millipore, |
| | | Billerica, |
| | | Massachusetts |
| DABCO | 1,4-diazabicyclo[2.2.2]octane | Alfa Aesar |
| 1,5-diazabycyclo[4.3.0]non-5-ene | 1,5-diazabycyclo[4.3.0]non-5-ene | Alfa Aesar |
| 7-methyl-1,5,7-triazabicyclo[4.4.0]dec-5ene | 7-methyl-1,5,7-triazabicyclo[4.4.0]dec-5ene | TCI America |
| 1,5,7-triazabicyclo[4.4.0]dec-5-ene | 1,5,7-triazabicyclo[4.4.0]dec-5-ene (pre-dissolved in thiol) | Sigma-Aldrich, |
| (pre-dissolved in thiol) | | St. Louis, Missouri |
| PDBU | tertiary amine catalyst obtained as POLYCAT DBU | Evonik Industries AG |
| | (1,8-diazabicyclo[5.4.0]undec-7-ene) | Essen, Germany |
| aniline | aniline | Alfa Aesar |
| N,N-dimethylaniline | N,N-dimethylaniline | Alfa Aesar |
| 2,6-dimethylaniline | 2,6-dimethylaniline | Alfa Aesar |
| 1-methylimidazole | 1-methylimidazole | Alfa Aesar |
| pyridine | pyridine | Alfa Aesar |
| 2,6-dimethylpyridine | 2,6-dimethylpyridine | Alfa Aesar |
| DMAP | 4-dimethylaminopyridine | Alfa Aesar |
| benzylamine | benzylamine | Alfa Aesar |
| dicyclohexylamine | dicyclohexylamine | Alfa Aesar |
| N,N-dicyclohexylmethylamine | N,N-dicyclohexylmethylamine | TCI America |
| 4-methylmorpholine | 4-methylmorpholine | Alfa Aesar |
| cyclohexylamine | cyclohexylamine | Alfa Aesar |
| piperidine | piperidine | Sigma-Aldrich |
| morpholine | morpholine | Alfa Aesar |
| JT403 | trifunctional amine-terminated | Huntsman Corporation, |
| | polyether obtained as | The Woodlands, Texas |
| | JEFFAMINE T-403 | |
| | Polyetheramine | |
| G328 | 1,3-benzenedimethanamine, | Mitsubishi Gas |
| | reaction products with epichlorohydrin, obtained as | Chemical Company, |
| | GASKAMINE 328 | New York, New York |
| CL1000 | Aliphatic secondary diamine | Dorf Ketal Chemicals, |
| | curative obtained as | Houston, Texas |
| | CLEARLINK 1000 | |
| JTHF100 | difunctional amine-terminated | Huntsman Corporation |
| | polyether obtained as | |
| | JEFFAMINE THF-100 | |
| | Polyetheramine | |
| NH1220 | aspartic acid, secondary | Covestro |
| | diamine obtained as | |
| | DESMOPHEN NH1220 | |
| 1-{bis[3-(dimethylamino)propyl]-amino}-2-propanol | 1-{bis[3-(dimethylamino)propyl]-amino}-2-propanol | Sigma-Aldrich |
| 1-methylpiperidine | 1-methylpiperidine | Alfa Aesar |
| quinuclidine | quinuclidine | Alfa Aesar |
| 2,2,6,6-tetramethylpiperidine | 2,2,6,6-tetramethylpiperidine | Alfa Aesar |
| 1-methylpyrrolidine | 1-methylpyrrolidine | Alfa Aesar |
| N-benzylmethylamine | N-benzylmethylamine | Alfa Aesar |
| 1,2,2,6,6-pentamethylpiperidine | 1,2,2,6,6-pentamethylpiperidine | Alfa Aesar |
| 2-{[2-(dimethylamino)-ethyl]methylamino}ethanol | 2-{[2-(dimethylamino)-ethyl]methylamino}ethanol | Alfa Aesar |
| 3-dimethylamino-1-propanol | 3-dimethylamino-1-propanol | Alfa Aesar |
| 2-[2-(dimethylamino)-ethoxy]ethanol | 2-[2-(dimethylamino)-ethoxy]ethanol | TCI America |

### Test Methods

### Overlap Shear Test Method

The performance of adhesives derived from uretdione oligomers was determined using overlap shear tests. Aluminum coupons (25 mm×102 mm×1.6 mm) were sanded with 220 grit sandpaper and wiped with isopropanol and dried. The uretdione oligomer and the thiol curative were each added to a plastic cup and mixed for 45 seconds to 90 seconds using a speed mixer (DAC 150 FV SpeedMixer from FlackTek, Landrum, S.C.). Catalyst was then added, and the mixture was mixed for 15 to 30 seconds using a combination of hand mixing with a wood applicator stick and the speed mixer. The mixture was then applied to a 25 mm×13 mm area on one end of the aluminum coupon, and two pieces of stainless steel wire (0.25 mm diameter) were placed in the resin to act as bondline spacers. One end of a second aluminum coupon was then pressed into to the mixture to produce an overlap of approximately 13 mm. A binder clip was placed on the sample, and it was allowed to cure for at least 18 hours. The samples were tested to failure in shear mode at a rate of 2.54 mm/minute using a tensile load frame with self-tightening grips (MTS Systems, Eden Prairie, Minn.). After failure, the length of the overlap area was measured. The overlap shear value was then calculated by dividing the peak load by the overlap area.

### Gel Point Determination

The pot life of uretdione oligomers was determined by monitoring the time required to reach a gel. The uretdione oligomer and the thiol curative were each added to a plastic cup and mixed for 30 seconds using a DAC 150 FV SpeedMixer at 3000 revolutions per minute (RPM). The mixture was mixed by hand for 10 seconds and then mixed again for 30 seconds using a speed mixer at 3000 RPM. Catalyst was then added and the mixture was mixed for 30 seconds using a speed mixer at 3000 RPM. The mixture was hand-mixed until the material could not be drawn without breaking, which was determined to be the gel point. Time was calculated from the addition of catalyst until the moment gelation occurred.

### FTIR Characterization

The infrared (IR) spectra of the oligomer samples and the cured adhesives were obtained using an infrared Fourier transform spectrometer (Nicolet 6700 FT-IR Spectrometer, Thermo Scientific, Madison, Wis.) equipped with a Smart iTR Diamond Attenuated Total Reflectance (ATR) accessory. For all the oligomers the isocyanate peak at 2260 cm⁻¹ was not present in the infrared spectrum, indicating that the isocyanate had reacted completely with the alcohols during the preparation of the oligomers. For all the oligomers, a strong uretdione signal at 1760 cm¹ was observed. For all the cured adhesives, the uretdione signal at 1760 cm¹ had nearly disappeared, indicating reaction of the uretdione group during the cure of the adhesives.

### NMR Analysis of DN3400

DN3400 was dissolved in deuterated dimethyl sulfoxide (DMSO) solvent. The ¹H proton spectrum was taken with a 500 MHz NMR (AVANCE III 500 MHz spectrometer equipped with a broadband cryoprobe from Bruker, Billerica, Mass.). The resulting spectrum had 5 major signals. Signals at 1.31 parts per million (ppm) and 1.55 ppm were attributed to methylene groups at the 3 and 4 positions and the 2 and 5 positions of the HDI derivatives, respectively. A signal at 3.17 ppm was attributed to methylene protons adjacent to a uretdione group. A signal at 3.34 ppm was attributed to methylene protons adjacent to an isocyanate group. A signal at 3.74 ppm was attributed to methylene protons adjacent to an isocyanurate group. The integrations of these three methylene signals were 1.35, 1.79, and 0.49, respectively. The published values for DN3400 are an equivalent weight of isocyanate of 193 g/equivalent and 22 weight percent isocyanate. The ratio of the integration of the signal at 3.17 ppm over the integration of the signal at 3.34 ppm is 0.75, which corresponds to 16 wt % uretdione. The ratio of the integration of the signal at 3.74 ppm over the integration of the signal at 3.34 ppm is 0.27, which corresponds to 3 wt % isocyanurate. The functionality of DN3400 is published as 2.5 (in “Raw Materials for Automotive Refinish Systems” from Bayer Materials Science, 2005), so the average molecular weight of the molecule in DN3400 is 193 grams/equivalent×2.5 equivalents/mole=482 grams/mol. For every 2.5 isocyanate methylene groups, there are 0.75*2.5=1.875 uretdione methylene groups. There are two methylene groups per uretdione group, so there are about 0.94 uretdione groups per molecule of DN3400.

### Calculation of Uretdione Functionality in Oligomers

A modified Carothers equation relates degree of polymerization (DP) to the average functionality (fav) and conversion (p) in a step growth polymerization [Carothers, Wallace (1936). “Polymers and Polyfunctionality”. Transactions of the Faraday Society. 32: 39-49]:

DP=2/(2−pfav)

This equation can be used to calculate the average degree of polymerization of each oligomer. Based on the degree of polymerization, the average number of uretdione groups in the oligomer (fUD) can be calculated by:

f(UD)=DP*(DN3400 molecules)*(uretdione groups per DN3400 molecule)/(total molecules)

where the values for “DN3400 molecules” and the “total molecules” correspond to the respective moles of molecules used to make the oligomer, and the value for “uretdione groups per DN3400 molecule” is 0.94, as calculated based on the NMR data (above).

### General Oligomer Preparation

Bismuth neodecanoate, DN3400 (HDI-based uretdione-containing material obtained as DESMODUR N 3400 from Covestro), the chain extender, and the capping group were added to a glass jar according to Tables 2 and 3. The amounts of alcohol that were added correspond to the equivalent values in Tables 2 to 3 (relative to the equivalents of isocyanate). The mixture was stirred magnetically at 700 RPM. Initially the mixture was hazy, and after about one minute, the mixture became clear and slightly warm. The mixture then continued to exotherm noticeably. Stirring was continued for a total of 5 minutes, and the oligomer was then allowed to cool to room temperature.

The composition and calculated uretdione functionality of each formulation are reported in Tables 2 and 3.

The mixtures were then tested for overlap shear (OLS) according to the Overlap Shear Test Method described above. Overlap shear test results are reported in Table 4 for the various formulations tested. The mixture was also tested for gel point according to the Gel Point Test Method described above. Gel point calculations are reported in Tables 5 to 7. Table 7 compares the impact of catalyst concentration on time to reach a gel point.

TABLE 2

| | ALCOHOL | | | DIOL | | | | | |
|---|---|---|---|---|---|---|---|---|---|
| PREPARATIVE | | Amount, | Relative | | Amount, | Relative | DN3400, | BIND | URETDIONE |
| EXAMPLE | Type | g | Equiv. | Type | g | Equiv. | g | CATALYST, g | FUNCTIONALITY |
| PEX-1A | 2-butanol | 0.903 | 0.63 | 2,2-dimethyl- | 0.368 | 0.37 | 3.72 | 0.0100 | 1.74 |
| | | | | 1,3-propanediol | | | | | |
| PEX-1B | 2-ethyl | 0.920 | 0.70 | 2,2-dimethyl- | 0.151 | 0.30 | 1.92 | 0.0052 | 1.48 |
| | hexanol | | | 1,3-propanediol | | | | | |
| PEX-1C | 2-butanol | 0.433 | 0.50 | 2,2-dimethyl- | 0.304 | 0.50 | 2.26 | 0.0061 | 2.51 |
| | | | | 1,3-propanediol | | | | | |
| PEX-1D | 2-butanol | 0.515 | 0.60 | 2,2-dimethyl- | 0.241 | 0.40 | 2.24 | 0.0061 | 1.88 |
| | | | | 1,3-propanediol | | | | | |
| PEX-1E | 2-ethyl | 4.02 | 1.0 | NA | NA | 0 | 5.95 | 0.02 | 0.94 |
| | hexanol | | | | | | | | |
| PEX-1F | 2-ethyl | 37.4 | 0.75 | 2,2-dimethyl- | 4.98 | 0.25 | 73.9 | 0.20 | 1.37 |
| | hexanol | | | 1,3-propanediol | | | | | |
| PEX-1G | 2-ethyl | 37.4 | 0.75 | 1,3-BD | 4.31 | 0.25 | 73.9 | 0.20 | 1.37 |
| | hexanol | | | | | | | | |

TABLE 3

| | ALCOHOL | | | DIOL | | |
|---|---|---|---|---|---|---|
| | | | Relative | | | Relative |
| EXAMPLE | Type | Amount, g | Equiv. | Type | Amount, g | Equiv. |
| EX-2 | 2-{[2-dimethylamino) | 7.61 | 0.64 | 2,2-dimethyl- | 1.55 | 0.36 |
| | ethyl]-methylamino}- | | | 1,3-propanediol | | |
| | ethanol | | | | | |
| EX-3 | 1-[bis[3-(dimethylamino)- | 12.7 | 0.64 | 2,2-dimethyl- | 1.55 | 0.36 |
| | propyl]amino]-2-propanol | | | 1,3-propanediol | | |
| EX-4 | 3-dimethylamino-1-propanol | 5.91 | 0.64 | 2,2-dimethyl- | 1.69 | 0.36 |
| | | | | 1,3-propanediol | | |
| EX-5 | 2-[2-(dimethylamino)- | 7.15 | 0.64 | 2,2-dimethyl- | 1.58 | 0.36 |
| | ethoxy]ethanol | | | 1,3-propanediol | | |
| EX-6 | 3-dimethylamino-1- | 0.86/4.7 | 0.64 | 2,2-dimethyl- | 2.14 | 0.36 |
| | propanol/2-butanol | | | 1,3-propanediol | | |
| EX-7 | 2-[2-(dimethylamino) | 4.1/2.4 | 0.64 | 2,2-dimethyl- | 1.85 | 0.36 |
| | ethoxy]-ethanol/2-butanol | | | 1,3-propanediol | | |

| | | BIND | | URETDIONE |
|---|---|---|---|---|
| EXAMPLE | DN3400, g | CATALYST, g | INDEX | FUNCTIONALITY |
| EX-2 | 15.8 | 0.043 | 1.00 | 1.73 |
| EX-3 | 15.7 | 0.043 | 1.00 | 1.73 |
| EX-4 | 17.3 | 0.047 | 1.00 | 1.72 |
| EX-5 | 16.2 | 0.044 | 1.00 | 1.72 |
| EX-6 | 21.9 | 0.059 | 1.00 | 1.72 |
| EX-7 | 19.0 | 0.051 | 1.00 | 1.71 |

TABLE 4

| | | | | | | | OVERLAP SHEAR | | |
|---|---|---|---|---|---|---|---|---|---|
| | URETDIONE | | | | | | ON ALUMINUM, | | |
| | RESIN | | CURING AGENT | | | | psi (MPa) | | |
| | | Amount, | | Amount, | | Amount, | | Std. | |
| EXAMPLE | Oligomer | g | Thiol | g | Catalyst | g | Average | Deviation | COMMENTS |
| EX-8 | PEX-1A | 5.00 | PETMP | 0.97 | Et₃N | 0.10 | 149.50 | 36.2 | |
| | | | | | | | (1.03) | (.25) | |
| EX-9 | PEX-1A | 5.00 | PETMP | 0.97 | AK54 | 0.11 | 189.07 | 23.6 | |
| | | | | | | | (1.30) | (0.16) | |
| EX-10 | PEX-1A | 5.00 | TMPTMP | 1.06 | AK54 | 0.11 | 191.2 | 9.3 | |
| | | | | | | | (1.32) | (0.06) | |
| EX-11 | PEX-1A | 5.00 | DMDO | 0.72 | AK54 | 0.11 | 73.6 | 24.7 | |
| | | | | | | | (0.51) | (0.17) | |
| EX-12 | PEX-1F | 5.00 | PETMP | 0.83 | AK54 | 0.09 | 6.5 | 1.5 | |
| | | | | | | | (0.05) | (0.01) | |
| EX-13 | PEX-1G | 5.00 | PETMP | 0.83 | AK54 | 0.09 | 39.7 | 7.9 | |
| | | | | | | | (0.27) | (0.05) | |
| EX-14 | PEX-1A | 5.00 | PETMP | 0.87 | AK54 | 0.09 | 223.8 | 1.4 | |
| | | | | | | | (1.54) | (0.01) | |
| EX-15 | PEX-1C | 3.00 | PETMP | 0.589 | AK54 | 0.04 | 86.8 | NA | |
| | | | | | | | (0.60) | | |
| EX-16 | PEX-1D | 3.00 | PETMP | 0.587 | AK54 | 0.04 | 110.7 | 12.7 | |
| | | | | | | | (0.76) | (0.09) | |
| EX-17 | PEX-1B | 3.00 | PETMP | 0.50 | AK54 | 0.033 | 57.6 | 32.0 | |
| | | | | | | | (0.40) | (0.22) | |
| EX-18 | PEX-1A | 3.00 | PETMP | 0.524 | AK54 | 0.057 | 101.8 | 22.3 | |
| | | | | | | | (0.70) | (0.15) | |
| EX-19 | PEX-1A | 3.00 | PETMP | 0.47 | AK54 | 0.057 | 110.1 | 4.4 | |
| | | | | | | | (0.76) | (0.03) | |
| EX-20 | PEX-1A | 3.00 | PETMP | 0.6208 | EX-3 | 0.2 | 527.5 | 34 | |
| | | | | | | | (3.64) | (0.23) | |
| Eχ-21 | PEχ-1A | 3.00 | PETMP | 0.6014 | EX-3 | 0.1 | 387.5 | 177 | |
| | | | | | | | (2.67) | (1.22) | |
| Eχ-22 | PEχ-1A | 3.00 | PETMP | 0.6208 | EX-2 | 0.2 | 219 | 15.5 | |
| | | | | | | | (1.51) | (0.11) | |
| Eχ-23 | PEχ-1A | 3.00 | PETMP | 0.6014 | EX-2 | 0.1 | 340 | 238 | |
| | | | | | | | (2.34) | (1.64) | |
| Eχ-24 | PEχ-1A | 3.00 | PETMP | 0.6208 | EX-4 | 0.2 | 190 | 178 | |
| | | | | | | | (1.31) | (1.23) | |
| Eχ-25 | PEχ-1A | 3.00 | PETMP | 0.6208 | EX-5 | 0.2 | 268 | 100 | |
| | | | | | | | (1.85) | (0.69) | |
| CEX-A | PEχ-1A | 3.00 | PETMP | 0.58 | no catalyst | 0 | NA | NA | Did not form an |
| | | | | | | | | | adequate bond for |
| | | | | | | | | | OLS testing |
| CEX-B | PEχ-1A | 3.00 | PETMP | 0.58 | TsOH*H₂O | 0.045 | NA | NA | Did not form an |
| | | | | | | | | | adequate bond for |
| | | | | | | | | | OLS testing |
| CEX-C | PEχ-1A | 3.00 | PETMP | 0.58 | BiND | 0.052 | NA | NA | Did not form an |
| | | | | | | | | | adequate bond for |
| | | | | | | | | | OLS testing |
| CEX-D | PEχ-1A | 3.00 | PETMP | 0.58 | ZnND | 0.052 | NA | NA | Did not form an |
| | | | | | | | | | adequate bond for |
| | | | | | | | | | OLS testing |
| CEX-E | PEX-1A | 3.00 | PETMP | 0.58 | DBTL | 0.25 | NA | NA | Did not form an |
| | | | | | | | | | adequate bond for |
| | | | | | | | | | OLS testing |
| CEX-F | PEX-1A | 3.00 | PETMP | 0.58 | zirconium | 0.097 | NA | NA | Did not form an |
| | | | | | 2,4-pentadionate | | | | adequate bond for |
| | | | | | | | | | OLS testing |
| CEX-G | PEX-1E | 3.00 | PETMP | 0.466 | AK54 | 0.50 | NA | NA | Cured, but did not |
| | | | | | | | | | form an adequate |
| | | | | | | | | | bond for OLS |
| | | | | | | | | | testing |
| CEX-H | PEX-1A | 5.00 | PETMP | 0.97 | DBU | 0.10 | NA | NA | Cured before OLS |
| | | | | | | | | | could be made |
| CEX-I | PEX-1A | 5.00 | PETMP | 0.97 | DBU | 0.04 | NA | NA | Cured before OLS |
| | | | | | | | | | could be made |

TABLE 5

| | | | | | | | GEL TIME | |
|---|---|---|---|---|---|---|---|---|
| | OLIGOMER | | THIOL | | CATALYST | | (hr = hours; | |
| | | Amount, | | Amount, | | Amount, | min = minutes; | |
| EXAMPLE | Type | g | Type | g | Type | g | sec = seconds) | |
| EX-26 | PEX-1A | 3.00 | PETMP | 0.582 | Et₃N | 0.039 | 5 min 45 sec | |
| EX-27 | PEX-1A | 3.00 | PETMP | 0.582 | AK54 | 0.101 | 6-7 | min |
| EX-28 | PEX-1A | 3.00 | PETMP | 0.582 | DABCO | 0.043 | >2 | hr |
| EX-29 | PEX-1A | 3.00 | PETMP | 0.582 | DABCO | 0.072 | <1 | min |
| | | | | | (pre-dissolved in thiol) | | | |
| EX-30 | PEX-1A | 3.00 | PETMP | 0.582 | aniline | 0.036 | >3 days < 7 days | |
| EX-31 | PEX-1A | 3.00 | PETMP | 0.582 | N,N-dimethylaniline | 0.046 | >3 days < 7 days | |
| EX-32 | PEX-1A | 3.00 | PETMP | 0.582 | 2,6-dimethylaniline | 0.046 | >3 days < 7 days | |
| EX-33 | PEX-1A | 3.00 | PETMP | 0.582 | 1-methylimidazole | 0.031 | >2 hr and < 12 hr | |
| EX-34 | PEX-1A | 3.00 | PETMP | 0.582 | pyridine | 0.026 | >3 days and < 7 days | |
| EX-35 | PEX-1A | 3.00 | PETMP | 0.582 | 2,6-dimethylpyridine | 0.023 | >3 days and < 7 days | |
| EX-36 | PEX-1A | 3.00 | PETMP | 0.582 | 4-dimethylaminopyrdine | 0.047 | 3 min 38 sec | |
| | | | | | (pre-dissolved in thiol) | | | |
| EX-37 | PEX-1A | 3.00 | PETMP | 0.582 | dicyclohexylamine | 0.069 | 1 min 30 sec | |
| EX-38 | PEX-1A | 3.00 | PETMP | 0.582 | 4-methylmorpholine | 0.039 | >6 hr and < 24 hr | |
| EX-39 | PEX-1A | 3.00 | PETMP | 0.582 | morpholine | 0.033 | >4 hr and < 24 hr | |
| EX-40 | PEX-1A | 3.00 | PETMP | 0.582 | JT403 | 0.061 | 4 | min |
| EX-41 | PEX-1A | 3.00 | PETMP | 0.582 | Gaskamine 328 PA | 0.057 | 2 min 30 sec | |
| EX-42 | PEX-1A | 3.00 | PETMP | 0.582 | CL1000 | 0.059 | 2 | min |
| EX-43 | PEX-1A | 3.00 | PETMP | 0.582 | JTHF 100 | 0.050 | 4 | min |
| EX-44 | PEX-1A | 3.00 | PETMP | 0.582 | 1-[bis[3-(dimethylamino)- | 0.094 | 6 | min |
| | | | | | propyl]amino]-2-propanol | | | |
| EX-45 | PEX-1A | 3.00 | PETMP | 0.582 | 1-methylpiperidine | 0.039 | 9 | min |
| EX-46 | PEX-P1A | 3.00 | PETMP | 0.582 | quinuclidine | 0.042 | 1 min 35 sec | |
| EX-47 | PEX-1A | 3.00 | PETMP | 0.582 | 2,2,6,6-tetramethylpiperidine | 0.054 | 1 min 10 sec | |
| EX-48 | PEX-1A | 3.00 | PETMP | 0.582 | 1-methylpyrrolidine | 0.032 | 3 | min |
| EX-49 | PEX-1A | 3.00 | PETMP | 0.582 | N-benzylmethylamine | 0.046 | 4 | min |
| EX-50 | PEX-1A | 3.00 | PETMP | 0.582 | 1,2,2,6,6-pentamethylpiperidine | 0.059 | 5 min 15 sec | |
| CEX-J | PEX-1A | 3.00 | PETMP | 0.582 | NH1220 (Aspartic Acid) | 0.089 | >14 | days |
| CEX-K | PEX-1A | 3.00 | PETMP | 0.582 | no catalyst | 0.000 | >24 | hr |
| CEX-L | PEX-1A | 3.00 | PETMP | 0.582 | TsOH*H₂O | 0.072 | >5 | days |
| CEX-C | PEX-1A | 3.00 | PETMP | 0.58 | BiND | 0.052 | >24 | h |
| CEX-N | PEX-1A | 3.00 | PETMP | 0.58 | ZnND | 0.052 | >24 | h |
| CEX-O | PEX-1A | 3.00 | PETMP | 0.58 | DBTL | 0.25 | >24 | h |
| CEX-P | PEX-1A | 3.00 | PETMP | 0.58 | zirconium 2,4-pentadionate | 0.097 | >24 | h |
| CEX-Q | PEX-1A | 3.00 | PETMP | 0.582 | 1,5-diazabycyclo(4.3.0)non-5-ene | 0.055 | <30 | sec |
| CEX-R | PEX-1A | 3.00 | PETMP | 0.582 | 7-methyl-1,5,7-triazabicyclo | 0.055 | <30 | sec |
| | | | | | (4.4.0)dec-5ene | | | |
| CEX-S | PEX-1A | 3.00 | PETMP | 0.582 | 1,5,7-triazabicyclo(4.4.0)dec- | 0.055 | <30 | sec |
| | | | | | 5-ene (Pre-Dissolved in thiol) | | | |
| CEX-T | PEX-1A | 3.00 | PETMP | 0.582 | DBU | 0.058 | Instantaneous | |
| CEX-U | PEX-1A | 3.00 | PETMP | 0.582 | PDBU | 0.072 | <30 | sec |

TABLE 6

| | | | CATALYST | | | | | |
|---|---|---|---|---|---|---|---|---|
| | | | CONTAINING | | | | GEL TIME | |
| | OLIGOMER | | OLIGOMER | | THIOL | | (hr = hours; | |
| | | Amount, | | Amount, | | Amount, | min = minutes; | |
| EXAMPLE | TYPE | g | TYPE | g | TYPE | g | sec = seconds) | |
| EX-51 | PEX-1A | 3.00 | EX-3 | 0.5 | PETMP | 0.679 | 5 | min |
| EX-52 | PEX-1A | 3.00 | EX-3 | 0.2 | PETMP | 0.621 | 10 | min |
| EX-53 | PEX-1A | 3.00 | EX-3 | 0.1 | PETMP | 0.601 | 1.5 | hr |
| EX-54 | PEX-1A | 3.00 | EX-2 | 0.5 | PETMP | 0.679 | 2 | min |
| EX-55 | PEX-1A | 3.00 | EX-2 | 0.2 | PETMP | 0.621 | 4 | min |
| EX-56 | PEX-1A | 3.00 | EX-2 | 0.1 | PETMP | 0.601 | 17 | min |
| EX-57 | PEX-1A | 3.00 | EX-4 | 0.2 | PETMP | 0.621 | 8 | min |
| EX-58 | PEX-1A | 3.00 | EX-5 | 0.2 | PETMP | 0.621 | 7 min 30 sec | |
| EX-59 | none | NA | EX-6 | 3.0 | PETMP | 0.582 | 48 | min |
| EX-60 | PEX-1A | 3.00 | EX-7 | 0.5 | PETMP | 0.679 | 28 | min |

TABLE 7

| | OLIGOMER | | THIOL | | CATALYST | | POT LIFE, | |
|---|---|---|---|---|---|---|---|---|
| | | Amount, | | Amount, | | Amount, | (min = minutes; | |
| EXAMPLE | Type | g | Type | g | Type | g | sec = seconds) | |
| EX-61 | PEX-1A | 3.0 | PETMP | 0.582 | benzylamine | 0.082 | 14 min 53 sec | |
| EX-62 | PEX-1A | 3.0 | PETMP | 0.582 | benzylamine | 0.041 | 16 | min |
| EX-63 | PEX-1A | 3.0 | PETMP | 0.582 | N,N-dicyclohexyl-methylamine | 0.149 | 3 min 35 sec | |
| EX-64 | PEX-1A | 3.0 | PETMP | 0.582 | N,N-dicyclohexyl-methylamine | 0.075 | 8 | min |
| EX-65 | PEX-1A | 3.0 | PETMP | 0.582 | cyclohexylamine | 0.019 | 5 min 25 sec | |
| EX-66 | PEX-1A | 3.0 | PETMP | 0.582 | cyclohexylamine | 0.038 | 4 | min |
| EX-67 | PEX-1A | 3.0 | PETMP | 0.582 | piperidine | 0.016 | 2 min 18 sec | |
| EX-68 | PEX-1A | 3.0 | PETMP | 0.582 | piperidine | 0.032 | 35 | sec |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-22. (canceled)

23. A two-part curable composition comprising:
a Part A composition comprising at least one uretdione-containing compound, the at least one uretdione-containing compound having an average uretdione ring functionality of at least 1.2, and wherein the at least one uretdione-containing compound has an average isocyanate functionality of less than 0.01;
a Part B composition comprising at least one thiol-containing compound, the at least one thiol-containing compound having an average sulfhydryl group functionality of at least 2; and
wherein at least one of the Part A composition and the Part B composition further comprises at least one accelerator for ring-opening addition of the at least one thiol-containing compound to the at least one uretdione-containing compound, and wherein the at least one accelerator comprises a nonacidic amine curative comprising pyridine, a substituted pyridine having 5 to 23 carbon atoms, or an amine having the formula NR¹R²R³ wherein:
R¹ represents H or a monovalent organic group having from 1 to 18 carbon atoms;
R² represents H or a monovalent organic group having from 1 to 18 carbon atoms;
R³ represents a monovalent organic group having from 2 to 18 carbon atoms; or
R² and R³ taken together represent a divalent organic group having from 2 to 18 carbon atoms, or
R¹, R², and R³ taken together represent a trivalent organic group having from 2 to 18 carbon atoms; and
wherein the amine curative does not comprise a substituted or unsubstituted amidine group.

24. The two-part curable composition of claim 23, wherein the at least one thiol-containing compound has an average sulfhydryl group functionality of at least 2.

25. The two-part curable composition of claim 23, wherein the at least one thiol-containing compound having an average sulfhydryl group functionality of less than or equal to 5.

26. The two-part curable composition of claim 23, wherein the Part A composition and the Part B composition are flowable at 20° C.

27. A cured composition comprising an at least partially cured reaction product of a curable composition comprising:
at least one uretdione-containing compound, the at least one uretdione-containing compound having an average uretdione ring functionality of at least 1.2, and wherein the at least one uretdione-containing compound has an average isocyanate functionality of less than 0.01;
at least one thiol-containing compound, the at least one thiol-containing compound having an average sulfhydryl group functionality of at least 2; and
at least one at least one accelerator for ring-opening addition of the at least one thiol-containing compound to the at least one uretdione-containing compound, wherein the at least one accelerator comprises a nonacidic amine curative having the formula NR¹R²R³ wherein:
R¹ represents H or a monovalent organic group having from 1 to 18 carbon atoms;
R² represents H or a monovalent organic group having from 1 to 18 carbon atoms;
R³ represents a monovalent organic group having from 2 to 18 carbon atoms; or
R² and R³ taken together represent a divalent organic group having from 2 to 18 carbon atoms, or
R¹, R², and R³ taken together represent a trivalent organic group having from 2 to 18 carbon atoms; and
wherein the amine curative does not comprise a substituted or unsubstituted amidine group.

28. The cured composition of claim 27, wherein the at least one thiol-containing compound has an average sulfhydryl group functionality of at least 2.5.

29. The cured composition of claim 27, wherein the at least one thiol-containing compound has an average sulfhydryl group functionality of less than or equal to 5.

30. The cured composition of claim 27, wherein the curable composition is flowable at 20° C. before curing.

31. A method of bonding first and second substrates, the method comprising:
i) providing a curable composition comprising:
at least one uretdione-containing compound, the at least one uretdione-containing compound having an average uretdione ring functionality of at least 1.2, and wherein the at least one uretdione-containing compound has an average isocyanate functionality of less than 0.01;
at least one thiol-containing compound, the at least one thiol-containing compound having an average sulfhydryl group functionality of at least 2; and
at least one accelerator for ring-opening addition of the at least one thiol-containing compound to the at least one uretdione-containing compound, wherein the at least one accelerator comprises a nonacidic amine curative comprising pyridine, a substituted pyridine having 5 to 23 carbon atoms, or an amine having the formula NR¹R²R³ wherein:
R¹ represents H or a monovalent organic group having from 1 to 18 carbon atoms;
R² represents H or a monovalent organic group having from 1 to 18 carbon atoms;
R³ represents a monovalent organic group having from 2 to 18 carbon atoms; or
R² and R³ taken together represent a divalent organic group having from 2 to 18 carbon atoms, or
R¹, R², and R³ taken together represent a trivalent organic group having from 2 to 18 carbon atoms; and
wherein the amine curative does not comprise a substituted or unsubstituted amidine group;
ii) contacting the curable composition with the first and second substrates; and
iii) at least partially curing the curable composition.

32. The method of claim 31, wherein the at least one thiol-containing compound has an average sulfhydryl group functionality of at least 2.5.

33. The method of claim 31, wherein the at least one thiol-containing compound has an average sulfhydryl group functionality of less than or equal to 5.

34. The method of claim 31, wherein the curable composition is flowable at 20° C. before curing.

35. A bonded assembly comprising a composition sandwiched between first and second substrates, wherein the composition comprises a reaction product of a curable composition comprising:
at least one uretdione-containing compound, the at least one uretdione-containing compound having an average uretdione ring functionality of at least 1.2, and wherein the at least one uretdione-containing compound has an average isocyanate functionality of less than 0.01;
at least one thiol-containing compound, the at least one thiol-containing compound having an average sulfhydryl group functionality of at least 2; and
at least one accelerator for ring-opening addition of the at least one thiol-containing compound to the at least one uretdione-containing compound, and wherein the at least one accelerator comprises a nonacidic amine curative comprising pyridine, a substituted pyridine having 5 to 23 carbon atoms, or an amine having the formula NR′R²R³ wherein:
R¹ represents H or a monovalent organic group having from 1 to 18 carbon atoms;
R² represents H or a monovalent organic group having from 1 to 18 carbon atoms;
R³ represents a monovalent organic group having from 2 to 18 carbon atoms; or
R² and R³ taken together represent a divalent organic group having from 2 to 18 carbon atoms, or
R¹, R², and R³ taken together represent a trivalent organic group having from 2 to 18 carbon atoms; and
wherein the amine curative does not comprise a substituted or unsubstituted amidine group.

36. The bonded assembly of claim 35, wherein the at least one thiol-containing compound has an average sulfhydryl group functionality of at least 2.5.

37. The bonded assembly of claim 35, wherein the at least one thiol-containing compound has an average sulfhydryl group functionality of less than or equal to 5.

38. The bonded assembly of claim 35, wherein the curable composition is flowable at 20° C. before curing.

39. A two-part curable composition comprising:
a Part A composition comprising at least one uretdione-containing compound, the at least one uretdione-containing compound having an average uretdione ring functionality of at least 1.2 and at least one pendant —CH₂NR⁴₂ group, wherein each R⁴ independently represents an alkyl group having from 1 to 8 carbon atoms, or two R⁴ groups taken together form an alkylene group having from 2 to 8 carbon atoms;
a Part B composition comprising at least one thiol-containing compound, the at least one thiol-containing compound having an average sulfhydryl group functionality of at least 2.
